(19) United States
(12) Patent Application Publication
(10) Pub. No.: US 2004/0225397 A1
(43) Pub. Date: Nov. 11, 2004

(54) System and method for determining worker productivity

(76) Inventor: Bradley L. Gotfried, Hobe Sound, FL (US)

Correspondence Address: AKERMAN SENTERFITT, P.O. BOX 3188, WEST PALM BEACH, FL, 33402-3188, US

(21) Appl. No.: 10/431,479

(22) Filed: May 7, 2003

(51) Int. Cl. G06F 19/00

(52) U.S. Cl. 700/111

(57) ABSTRACT

A worker productivity tracking system for determining the productivity of a worker using a manufacturing device. The worker productivity tracking system may include a central processing unit coupled to one or more remote processing units. A remote processing unit may track the amount of time a worker needs to complete a task. The remote processing unit may send the worker data to the central processing unit. The central processing unit may compare the worker data with manufacturing process information to determine the productivity of the worker. A memory card may be used by the remote processing unit to determine whether a worker is able to operate a manufacturing device.

### FIELD OF THE INVENTION

This invention is directed generally to computer tracking systems, and more particularly, to integrated production tracking and worker compensation calculation systems.

### BACKGROUND

The productivity of many labor intensive manufacturing processes are subject to the performance and diligence of the workers completing the manufacturing tasks. Often, each worker at a particular seniority level is paid the same wage regardless of the level of productivity of one worker as compared with other workers in the same seniority level. This situation is often the case because paying each worker the same salary reduces administrative expenses. However, paying each worker the same salary in manufacturing industries where some workers clearly work harder than other workers does not result in each worker working at each worker's highest level of productivity. Rather, workers often have no incentive to work more diligently than the average worker. Thus, many workers work only as hard as the average worker. In the end, the productivity of the workers suffers. Thus, a need exists for providing workers with an incentive to work diligently in manufacturing industries.

Labor intensive industries also typically lack tracking systems for determining the productivity of each worker. Instead, the productivity of an entire process is tracked, which can be a tracking of only the cumulative efforts of all of the workers who work in that particular manufacturing process, as opposed to the productivity level of each worker. Even where the efforts of each worker are tracked, many tracking systems calculate and report the productivity of each worker on a weekly, biweekly, or monthly basis where more immediate information would be more desirable. Thus, a need exists for a worker productivity tracking system that provides worker productivity information in a more expedient manner.

### SUMMARY OF THE INVENTION

This invention is a directed to a worker productivity tracking system. The worker productivity tracking system may include a central processing unit for receiving manufacturing process information and worker data, processing the worker data received from one or more remote processing units, and determining the productivity of at least one worker by comparing manufacturing process information with the worker data. The manufacturing process information may include the average amount of time needed for a worker to complete a variety of manufacturing tasks. The central processing unit may be in communication with one or more remote processing units. The remote processing units may also be in communication with one or more manufacturing devices and may be attached to the manufacturing devices. The remote processing units receive worker data from the manufacturing devices and transmit the worker data to the central processing unit.

In one embodiment, the worker productivity tracking system may be used to track the productivity of one or more workers using sewing machines. The worker productivity tracking system includes a remote processing unit coupled to a sewing machine for recording worker data, which may include the amount of time that the sewing machine is operating. The worker processing unit may determine whether a worker is authorized to use a particular manufacturing device and allow the worker to use the device if authorized. Once, the worker has begun to use the manufacturing device, the remote processing unit may transmit worker data from the remote processing unit to the central processing unit.

The central processing unit may receive manufacturing process information from one or more remote processing units. In one embodiment, an information transfer device may be included in the remote processing unit and may receive manufacturing process information from a memory card. The remote processing unit may transfer the manufacturing process information to the central processing unit. The central processing unit may receive the manufacturing process data and compare the manufacturing process data with the worker data.

The central processing unit may generate results of the comparison, which may show the productivity of the one or more workers. The results may also include rankings of the workers based on each worker's productivity. The central processing unit may continuously receive worker data, compare the manufacturing process information with the worker data, generate results, and display the results. A worker may be compensated immediately upon completion of a task or at another time based on the central processing units indication that the task has been completed. Thus, the central processing unit may operate in a real-time format.

An advantage of this invention is that the worker productivity tracking system may operate in a real-time format and continuously update the productivity information related to one or more workers.

Another advantage of this invention is that the worker productivity tracking system prevents workers from using manufacturing equipment that workers are unauthorized to use.

Yet another advantage of this invention is that the worker productivity tracking system helps encourage workers to work more diligently because the workers know that their productivity is being tracked and that their compensation is based on their levels of productivity.

### BRIEF DESCRIPTION OF THE DRAWINGS

The accompanying drawings, which are incorporated in and form a part of the specification, illustrate embodiments of the presently disclosed invention and, together with the description, disclose the principles of the invention.

FIG. 1 is a schematic diagram of a worker productivity tracking system of this invention.

FIG. 2 is a perspective view of a manufacturing device coupled to the worker productivity tracking system of FIG. 1.

### DETAILED DESCRIPTION OF THE INVENTION

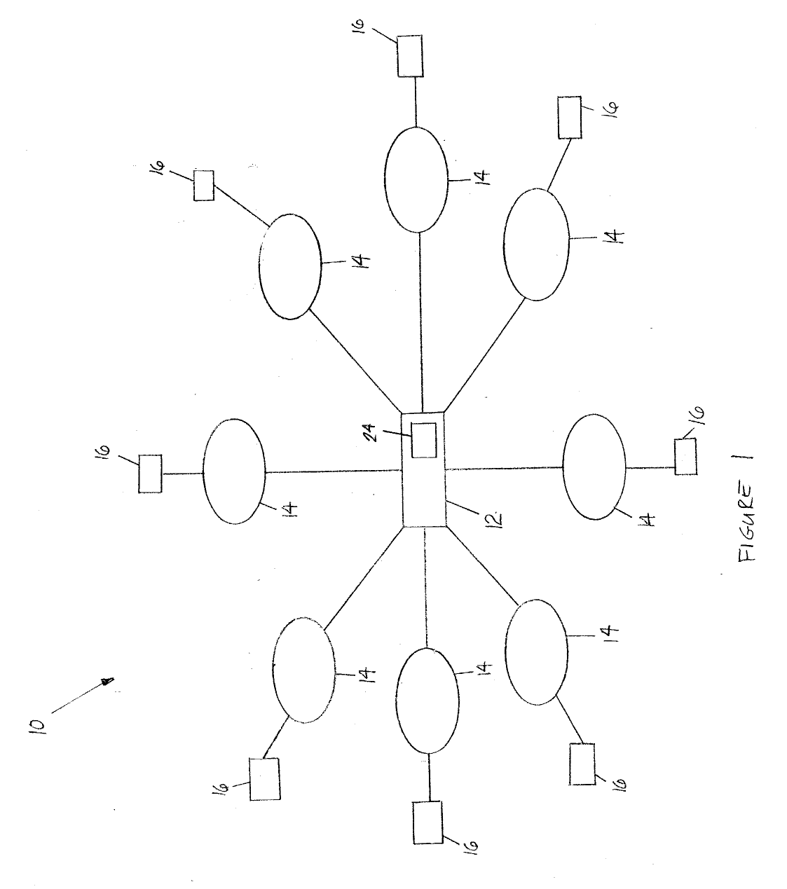

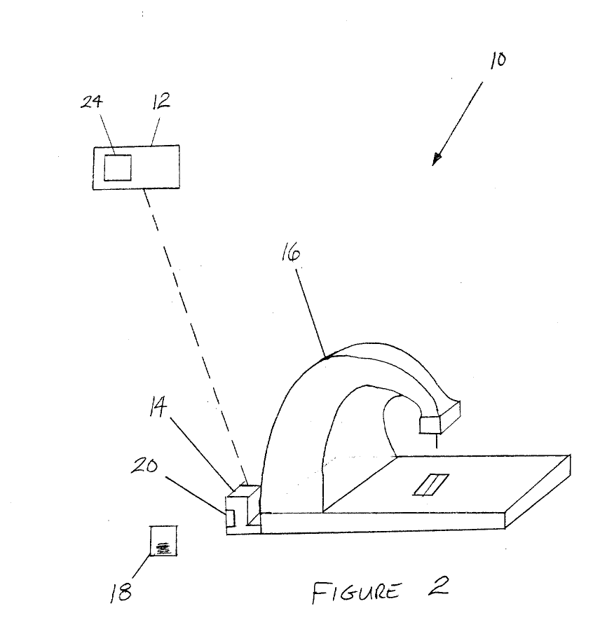

As shown in FIGS. 1 and 2, this invention is a worker productivity tracking system 10. Worker productivity tracking system 10 tracks the amount of time taken by a worker to complete a task. Worker productivity tracking system 10 may be configured to track two or more workers working simultaneously, during overlapping periods, or at different times. Worker productivity tracking system 10 may track tasks, such as but not limited to, manufacturing steps, assembly tasks, processing tasks and others. Worker productivity tracking system 10 may determine whether a worker is authorized to use a particular manufacturing device and prevent a worker from using a manufacturing device if the worker is not authorized to use the device. Worker productivity tracking system 10 may also provide productivity data by comparing the amount of time needed by a worker to complete a task with an average amount of time needed for workers to complete that same task. Worker productivity tracking system 10 may provide the productivity data on a real-time basis. In other words, worker productivity tracking system 10 may provide the productivity data as the system receives it. Thus, the productivity levels may be continuously updated.

Worker productivity tracking system 10 may include a central processing unit 12 for comparing manufacturing process information with worker data. Manufacturing process information may be any and all information relating to a manufacturing process, such as, for example and not limitation, time periods needed to complete particular tasks, identification of a particular manufacturing device to which a particular worker is authorized to work, and other information. Worker data may be, but is not limited to, the actual amount of time a worker needed to complete a particular task. Central processing unit 12 may be a personal computer, main frame computer, microcontroller, or other device capable of performing the functions described herein.

Worker productivity tracking system 10 may also include one or more remote processing units 14 for receiving worker data from a manufacturing device 16. Remote processing unit 14 may be in communication with a manufacturing device 16 and the central processing unit 12. In at least one embodiment, remote processing unit 14 may be coupled to manufacturing device 16 to control operation of manufacturing device 16. In another embodiment, remote processing unit 14 is not coupled to manufacturing device 16 but positioned so that remote processing unit 14 is capable of recording data, which may be, but is not limited to, the amount of time manufacturing device 16 is operated. Remote processing unit 14 may communicate with manufacturing device 16 and central processing unit 12 using a wireline network, a wireless network, or other device. Remote processing unit 14 may be any device capable of recording various data relating to operation of the manufacturing device 16. For instance, remote processing unit 14 may be a personal computer, microcontroller, or other such device.

Remote processing unit 14 may include sensors 20 for determining, for example, the amount of time that manufacturing device 16 is operating. Remote processing unit 14 may be coupled to manufacturing device 16 so that remote processing unit may record the amount of time manufacturing device 16 is operated and other data and Remote processing unit 14 may also be able to receive information from a memory card 18, which may also be referred to as a ticket. In one embodiment, remote processing unit 14 may receive manufacturing process information from memory card 18. Remote processing unit 14 may transfer the manufacturing process information to the central processing unit 12 for analysis. Remote processing unit 14 may include an information transfer device 22 for transferring manufacturing process information from memory card 18 to remote processing unit 14. The information transfer device 22 may include, but is not limited to, an optical scanner, a disk drive, a compact disc (CD) drive, digital video disc (DVD) drive, bar code scanner, card reader, or other such device. Memory card 18 may be, but is not limited to, a CD, a DVD, a disk, a ticket, or other device.

Worker productivity tracking system 10 may operate by a memory card 18 being generated or by manufacturing process information for a particular employee being stored on the memory card. Memory card 18 may be generated by a component of central processing unit 12 or another device. The worker may then approach a manufacturing device 16 assigned to the worker. Remote processing unit 14 may determine whether an individual worker is authorized to use a particular manufacturing device 16 by analyzing a code contained in memory card 18. The code may or may not be unique to an individual worker. If the worker is authorized to work on the manufacturing device 16, the worker may use the manufacturing device 16. If the worker is not authorized to use manufacturing device 16, the remote processing unit may generate an error message and send the error message to central processing unit 12 and prevent the manufacturing device 16 from operating.

Once the worker productivity tracking system 10 has determined that the worker is using the correct manufacturing device 16, the worker may begin transferring the manufacturing process information stored on memory card 18 to remote processing unit 14. The manufacturing process information may be transferred by placing memory card 18 in close proximity to information transfer device 22. The manufacturing process information stored on memory card 18 is transferred from memory card 18 to remote processing unit 14 by actuating information transfer device 22. Once the worker begins using manufacturing device 16, remote processing unit 14 begins transmitting worker data and manufacturing process information to central processing unit 12.

Central processing unit 12 continuously receives the worker data and compares the worker data with the manufacturing process information to determine the productivity of the worker. Remote processing unit 14 may continuously provide the worker data to central processing unit 12 in a real-time format. Central processing unit 12 may continuously compare the worker data with the manufacturing process information. Central processing unit 12 may determine whether a worker is properly performing a task using manufacturing device 16. By monitoring the activities of a worker, worker productivity system 10 may determine whether a worker is working efficiently and whether a worker is working on the proper task and not intentionally or unintentionally working on another task. Central processing unit 12 may provide the results of this comparison in many formats. For instance, central processing unit 12 may display the results on a display screen 24, such as, but not limited to, a monitor. Central processing unit 12 may also provide the results in a printed document or in an electronic message, such as an email message. Once the task assigned to a particular worker has been completed, remote processing unit 14 generates a signal that is sent to central processing unit indicating that the worker has successfully completed the task.

Central processing unit 12 may be coupled to one or more remote processing units 14. Central processing unit 12 may perform individual comparisons of each worker. In addition, central processing unit 12 may compare all of the workers together and rank each worker according to each worker's productivity. Each worker's productivity may be used as the only factor or one of numerous factors in compensating each worker.

In one embodiment, manufacturing device 16 is a sewing machine. Memory card 18 may be a ticket having a bar code and contain manufacturing process information relating to the process of using the sewing machine. For instance, manufacturing process information may include the average amount of time needed for a worker to use manufacturing device 16 to sew pieces of clothing together to form a wearable clothing item, such as, but not limited to, a pair of pants, a shirt, a dress, or other clothing item. The manufacturing process information may also include the amount of time needed to stitch an entire bundle of clothing. A bundle of clothing may be defined as including a specific number of clothing items or a range of the number of clothing items. The manufacturing process information may also include the number of pieces of clothing forming a bundle of clothing, and the number of steps needed to assemble one or more pieces of clothing.

Memory card 18 may include manufacturing process information for one or more items of clothes and for one or more manufacturing devices 16. The manufacturing process information is transferred from memory card 18 to remote processing unit 14 by actuating information transfer device 22. The remote processing unit 14 determines whether the worker is authorized to use manufacturing device 16. If the worker is authorized to use manufacturing device 16, the worker begins work and remote processing unit 14 begins transferring the manufacturing process information to central processing unit 12. If the worker is not authorized, central processing unit 12 may be notified of an improper attempted usage of a particular manufacturing device 16 and the individual that attempted to log into the manufacturing device. Central processing unit 12 compares the manufacturing process information with worker data and generates productivity results in a real-time format. Once the worker has completed a task, remote processing unit 14 notifies the central processing unit 12 that the worker has completed the task. The worker may or may not be compensated for completing the task at that point in time or at a later time, such as at the end of the day, week, or according to another time period. The worker may be compensated through direct payment, direct deposit into a worker's account at a financial institution such as a bank, applying credit to an internal payroll system, or other method.

The foregoing is provided for purposes of illustrating, explaining, and describing embodiments of this invention. Modifications and adaptations to these embodiments will be apparent to those skilled in the art and may be made without departing from the scope or spirit of this invention.

I claim:

1. A worker productivity tracking system, comprising:
a central processing unit capable of receiving manufacturing process information and worker data, processing the worker data received from at least one remote processing unit, and determining productivity of at least one worker by comparing the manufacturing process information and the worker data;
at least one memory card containing the manufacturing process information, wherein the manufacturing process information relates to performance of the at least one manufacturing device; and
the at least one remote processing unit coupled to at least one manufacturing device and in communication with the central processing unit; wherein the at least one remote processing unit is capable of receiving manufacturing process information from the at least one memory card and transferring the manufacturing process information to the central processing unit; and wherein the at least one remote processing unit is capable of receiving worker data from the at least one manufacturing device and transferring the worker data to the central processing unit.

2. The worker productivity tracking system of claim 1, wherein the central processing unit is coupled to the at least one remote processing unit with a wireline network.

3. The worker productivity tracking system of claim 1, wherein the central processing unit is coupled to the at least one remote processing unit with a wireless network.

4. The worker productivity tracking system of claim 1, wherein the remote processing unit is coupled to the at least one manufacturing device with a wireline network.

5. The worker productivity tracking system of claim 1, wherein the remote processing unit is coupled to the at least one manufacturing device with a wireless network.

6. The worker productivity tracking system of claim 1, wherein the at least one remote processing unit comprises a scanner.

7. The worker productivity tracking system of claim 1, wherein the memory card comprises a ticket.

8. The worker productivity tracking system of claim 1, further comprising a bar code on the at least one memory card.

9. The worker productivity tracking system of claim 1, wherein the manufacturing process information comprises the amount of time needed on average to complete a manufacturing process.

10. The worker productivity tracking system of claim 1, wherein the at least one manufacturing device is at least one sewing machine.

11. The worker productivity tracking system of claim 1, wherein the manufacturing process information comprises information relating to an amount of time needed to stitch a bundle of clothing.

12. The worker productivity tracking system of claim 1, wherein the manufacturing process information comprises a number equal to a number of pieces of clothing forming a bundle of clothing.

13. The worker productivity tracking system of claim 1, wherein the manufacturing process information comprises a number equal to a number of steps needed to assemble one or more pieces of clothing.

14. A method of determining the productivity of a worker, comprising:
placing a memory card in a position enabling a remote processing unit coupled to a manufacturing device to receive manufacturing process information stored in the memory card;
transferring the manufacturing process information from the memory card to a central processing unit;
processing the manufacturing process information stored on the memory card;
receiving worker data at the remote processing unit from at least one manufacturing device, the worker data relating to the completion of at least one task by a worker using the at least one manufacturing device;
sending the worker data from the at least one remote processing unit to a central processing unit;
comparing the worker data with the manufacturing process information;
generating productivity results from the worker data; and
displaying the productivity results in a real-time format.

15. The method of determining the productivity of a worker of claim 14, further comprising determining a worker's compensation based at least in part on the productivity results.

16. The method of determining the productivity of a worker of claim 14, further comprising authorizing the at least one memory card.

17. The method of determining the productivity of a worker of claim 14, wherein receiving worker data at the remote processing unit from at least one manufacturing device comprises receiving worker data from at least one sewing machine.

18. The method of determining the productivity of a worker of claim 14, wherein transferring the manufacturing process information from the memory card to a central processing unit comprises transferring information relating to an amount of time needed to stitch a bundle of clothing.

19. The method of determining the productivity of a worker of claim 14, wherein transferring the manufacturing process information from the memory card to a central processing unit comprises transferring a number equal to a number of pieces of clothing forming a bundle of clothing.

20. The method of determining the productivity of a worker of claim 14, wherein transferring the manufacturing process information from the memory card to a central processing unit comprises transferring a number equal to a number of discrete steps needed to assemble one or more pieces of clothing.

21. A method of determining the productivity of a worker, comprising:
storing manufacturing process information relating to at least one task on a memory card;
placing the memory card in a position enabling a remote processing unit coupled to a manufacturing device to receive manufacturing process information stored in the memory card;
receiving worker data at the remote processing unit from at least one manufacturing device, the worker data relating to the completion of at least one task by a worker using the at least one manufacturing device;
sending the worker data from the at least one remote processing unit to a central processing unit;
determining whether a worker producing the worker data properly completed the at least one task; and
compensating the worker if the worker completed the at least one task.

22. The method of determining the productivity of a worker of claim 21, wherein the at least one task comprises sewing at least one piece of clothing.
